(19) United States
(12) Patent Application Publication
(10) Pub. No.: US 2026/0153777 A1
(43) Pub. Date: Jun. 4, 2026

(54) OPTICAL SWITCH AND LIGHT STEERING SYSTEM INCLUDING THE OPTICAL SWITCH

(71) Applicant: SAMSUNG ELECTRONICS CO.,LTD., Suwon-si (KR)

(72) Inventors: Minkyung LEE, Suwon-si (KR); Sunil Kim, Suwon-si (KR); Byunggil Jeong, Suwon-si (KR)

(73) Assignee: SAMSUNG ELECTRONICS CO.,LTD., Suwon-si (KR)

(21) Appl. No.: 19/189,813

(22) Filed: Apr. 25, 2025

(30) Foreign Application Priority Data
Dec. 2, 2024 (KR) 10-2024-0176721

(51) Int. Cl. G02F 1/313; G01S 7/4911; G02F 1/21

(52) U.S. Cl. CPC G02F 1/3136; G01S 7/4911; G02F 1/212; G02F 1/217; G02F 1/3133

(57) ABSTRACT

Provided is an optical switch including a first multimode interferometer and a second multimode interferometer spaced apart from each other, a plurality of waveguides between the first multimode interferometer and the second multimode interferometer, and a directional coupler connected to at least one waveguide of the plurality of waveguides, the directional coupler including a diode.

### CROSS-REFERENCE TO RELATED APPLICATION

This application is based on and claims priority under 35 U.S.C. § 119 to Korean Patent Application No. 10-2024-0176721, filed on Dec. 2, 2024, in the Korean Intellectual Property Office, the disclosure of which is incorporated by reference herein in its entirety.

### BACKGROUND

### 1. Field

The disclosure relates to an optical switch and a light steering system including the optical switch.

### 2. Description of Related Art

Photonic integrated circuits (PICs) applied to light steering systems are microchips in which two or more photonic components including a waveguide and a coupler are connected to each other to generate, transmit, process, or detect optical signals. Such PICs may include an optical switch to direct optical signals along an intended path. An optical switch utilizing the thermo-optic effect may change an optical path by modulating the phase of a portion of light by using a heater.

### SUMMARY

Provided are an optical switch and a light steering system including the optical switch.

Additional aspects will be set forth in part in the description which follows and, in part, will be apparent from the description, or may be learned by practice of the presented embodiments of the disclosure.

According to an aspect of the disclosure, an optical switch may include: a first multimode interferometer; a second multimode interferometer spaced apart from the first multimode interferometer; a plurality of waveguides connecting the first multimode interferometer and the second multimode interferometer; and a directional coupler connected to at least one waveguide of the plurality of waveguides, the directional coupler including a diode.

The at least one waveguide connected to the directional coupler may include a first waveguide portion and a second waveguide portion spaced apart from the first waveguide portion, and the directional coupler may be configured to provide an optical path between the first waveguide portion and the second waveguide portion.

The directional coupler and the first waveguide portion may be arranged so that a first coupling region is formed between the directional coupler and the first waveguide portion, and the directional coupler and the second waveguide portion are arranged so that a second coupling region is formed between the directional coupler and the second waveguide portion.

The directional coupler may be further configured to modulate, by heat generated from the diode, a phase of light passing through the directional coupler.

The directional coupler may include a first doped region and a second doped region.

The first doped region and the second doped region may be between the first coupling region and the second coupling region.

The first doped region and the second doped region may be outside the first coupling region and the second coupling region.

The optical switch may further include: at least one input port connected to the first multimode interferometer; and a plurality of output ports connected to the second multimode interferometer.

The plurality of waveguides may include a silicon-based material.

The directional coupler may include a silicon-based material.

According to an aspect of the disclosure, a light steering system includes: a light source; a light steering device including a plurality of optical switches configured to steer light incident from the light source; and a detector configured to detect the steered light, wherein each of the plurality of optical switches may include: a first multimode interferometer; a second multimode interferometer spaced apart from the first multimode interferometer; a plurality of waveguides connecting the first multimode interferometer and the second multimode interferometer; and a directional coupler connected to at least one waveguide of the plurality of waveguides, the directional coupler including a diode.

The light source may be configured to emit frequency modulated continuous wave (FMCW) light.

The at least one waveguide connected to the directional coupler may include a first waveguide portion and a second waveguide portion spaced apart from the first waveguide portion, and the directional coupler may be configured to provide an optical path between the first waveguide portion and the second waveguide portion.

The directional coupler and the first waveguide portion may be arranged so that a first coupling region is formed between the directional coupler and the first waveguide portion, and the directional coupler and the second waveguide portion are arranged so that a second coupling region is formed between the directional coupler and the second waveguide portion.

The directional coupler may include a first doped region and a second doped region.

The first doped region and the second doped region may be between the first coupling region and the second coupling region.

The first doped region and the second doped region may be outside the first coupling region and the second coupling region.

The light steering system may further include: at least one input port connected to the first multimode interferometer; and a plurality of output ports connected to the second multimode interferometer.

The plurality of waveguides may include a silicon-based material.

The directional coupler may include a silicon-based material.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an optical switch according to one or more embodiments;

FIG. 2 is a simulation result illustrating an example of a temperature distribution of the optical switch illustrated in FIG. 1;

FIG. 3 illustrates an optical switch according to a related embodiment;

FIG. 4 is a simulation result illustrating an example of a temperature distribution of the optical switch shown in FIG. 3;

FIG. 5 is a simulation result illustrating another example of a temperature distribution of the optical switch shown in FIG. 3;

FIG. 6 illustrates an optical switch according to one or more other embodiments; and

FIG. 7 illustrates a light steering system according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, embodiments will be described with reference to the accompanying drawings. In the drawings, like reference numerals refer to like elements, and the sizes of elements may be exaggerated for clarity of illustration. The embodiments described herein are for illustrative purposes only, and various modifications may be made therein.

In the following description, when an element is referred to as being “above” or “on” another element, it may be directly on an upper, lower, left, or right side of the other element while making contact with the other element or may be above an upper, lower, left, or right side of the other element without making contact with the other element. The terms of a singular form may include plural forms unless otherwise mentioned. It will be further understood that the terms “comprises” and/or “comprising” used herein specify the presence of stated features or elements, but do not preclude the presence or addition of one or more other features or elements.

An element referred to with the definite article or a demonstrative determiner may be construed as the element or the elements even though it has a singular form. Operations of a method may be performed in an appropriate order unless explicitly described in terms of order or described to the contrary, and are not limited to the stated order thereof.

In the present specification, terms such as “unit” or “module” may be used to denote a unit that has at least one function or operation and is implemented with hardware, software, or a combination of hardware and software.

Furthermore, line connections or connection members between elements depicted in the drawings represent functional connections and/or physical or circuit connections by way of example, and in actual applications, they may be replaced or embodied with various additional functional connections, physical connections, or circuit connections.

Examples or exemplary terms are just used herein to describe technical ideas and should not be considered for purposes of limitation unless defined by the claims.

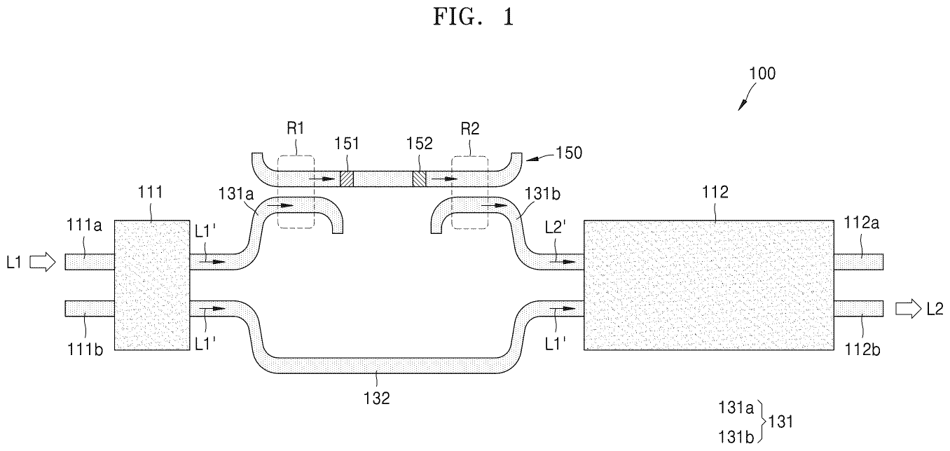

FIG. 1 illustrates an optical switch 100 according to one or more embodiments. The optical switch 100 shown in FIG. 1 may be a Mach-Zehnder interferometer (MZI)-type optical switch using a multimode interferometer (MMI).

Referring to FIG. 1, a first MMI 111 and a second MMI 112 are arranged spaced apart from each other on a substrate, and a plurality of waveguides including upper waveguide 131 and a lower waveguide 132 connect the first MMI 111 and the second MMI 112 to each other.

At least one of a first input port 111a and a second input port 111b through which a first beam L1 is input is connected to the first MMI 111. Although FIG. 1 illustrates an example in which two input ports, that is, the first input port 111a and the second input port 111b, are connected to the first MMI 111, various numbers of input ports may be connected to the first MMI 111. The second MMI 112 is connected to a plurality of output ports including a first output port 112a and a second output port 112b through which a second beam L2 is output. Although FIG. 1 illustrates an example in which the second MMI 112 is connected to two output ports, that is, the first output port 112a and the second output port 112b, various numbers of output ports may be connected to the second MMI 112.

The first MMI 111 and the second MMI 112 may be connected to each other though the plurality of waveguides including the upper waveguide 131 and the lower waveguide 132. Here, the plurality of waveguides including the upper waveguide 131 and the lower waveguide 132 may include, for example, a silicon-based material such as silicon. However, the plurality of waveguides including the upper waveguide 131 and the lower waveguide 132 are not limited thereto. FIG. 1 illustrates an example in which two waveguides, that is, the upper waveguide 131 and the lower waveguide 132, connect the first MMI 111 and the second MMI 112 to each other. However, embodiments are not limited thereto, and various numbers of waveguides may be provided between the first MMI 111 and the second MMI 112.

The first beam L1, which is input into the first MMI 111 from the outside (a light source or another MMI), for example, through the first input port 111a, may be divided into two sub-beams L1′ by the first MMI 111, and the two sub-beams L1′ may be output respectively through the upper waveguide 131 and the lower waveguide 132.

The upper waveguide 131 may include a first waveguide portion 131a and a second waveguide portion 131b that are arranged spaced apart from each other. In addition, the upper waveguide 131 may be coupled and/or connected to a directional coupler 150. The directional coupler 150 may include, for example, a silicon-based material such as silicon. However, the directional coupler 150 is not limited thereto.

The directional coupler 150 may form an optical path between the first waveguide portion 131a and the second waveguide portion 131b that are spaced apart from each other. To this end, a first coupling region R1 may be formed between the first waveguide portion 131a of the upper waveguide 131 and the directional coupler 150, and a second coupling region R2 may be formed between the second waveguide portion 131b of the upper waveguide 131 and the directional coupler 150. Here, the length of the first coupling region R1 may be determined such that the optical energy of the sub-beam L1′ passing through the first waveguide portion 131a may be entirely transferred to the directional coupler 150. In addition, the length of the second coupling region R2 may be determined such that the optical energy of a modulated beam L2′ (described later) passing through the directional coupler 150 may be entirely transferred to the second waveguide portion 131b.

The directional coupler 150 may include a diode to modulate, using the thermo-optic effect, the phase of the sub-beam L1′ passing through the directional coupler 150. Here, the diode may operate as a heater for heating the directional coupler 150 to a predetermined temperature. The diode may generate Joule heat from current applied between both ends of the directional coupler 150, thereby heating the directional coupler 150, changing the refractive index of a material of the directional coupler 150, and modulating the phase of the sub-beam L1′ passing through the directional coupler 150.

The diode that generates Joule heat may be implemented by forming a first doped region 151 and a second doped region 152 spaced apart from each other in the directional coupler 150. Here, the first doped region 151 and the second doped region 152 may be provided in the directional coupler 150 between the first coupling region R1 and the second coupling region R2.

The diode may be configured as, for example, a p-i-n diode. In this case, the first doped region 151 and the second doped region 152 may be a p-doped region and an n-doped region, respectively. For example, the p-doped region and the n-doped region may be formed spaced apart from each other in the directional coupler 150. The p-i-n diode may be implemented by the p-doped region, an undoped region, and the n-doped region that are formed in the directional coupler 150. When the directional coupler 150 includes, for example, a Group IV semiconductor material such as Si, the p-doped region may include an element such as boron (B), aluminum (Al), gallium (Ga), or indium (In), and the n-doped region may include an element such as phosphorous (P), arsenide (As), or antimony (Sb). However, embodiments are not limited thereto.

While the p-i-n diode is described as an example of the diode in the description above, embodiments are not limited thereto, and the diode may be a p-i-p diode or an n-i-n diode. In the p-i-p diode, both the first doped region 151 and the second doped region 152 may be p-doped regions, and in the n-i-n diode, both the first doped region 151 and the second doped region 152 may be n-doped regions.

The directional coupler 150 may be heated by applying current to the diode. Here, the directional coupler 150 may be heated to an intended temperature by adjusting the amount of current applied to the diode, thereby modulating the phase of the sub-beam L1′ as intended. The directional coupler 150 including the diode as described above may perform both the waveguide function and the heater function.

The sub-beam L1′ output from the first MMI 111 and passing through the first waveguide portion 131a of the upper waveguide 131 is transferred to the directional coupler 150 through the first coupling region R1. The sub-beam L1′, passing through the directional coupler 150, is phase modulated by heating the directional coupler 150 with the diode and is converted into a modulated beam L2′. Then, the modulated beam L2′ is transferred to the second waveguide portion 131b of the upper waveguide 131 through the second coupling region R2.

The modulated beam L2′ passing through the second waveguide portion 131b of the upper waveguide 131 and the sub-beam L1′ passing through the lower waveguide 132 are combined in the second MMI 112. In the second MMI 112, an output port may be determined from the first output port 112a and the second output port 112b based on a phase difference between the modulated beam L2′ and the sub-beam L1′. Then, a second beam L2 in which the modulated beam L2′ and the sub-beam L1′ are combined may be output through the determined output port. In the example shown in FIG. 1, the second beam L2, in which the modulated beam L2′ and the sub-beam L1′ are combined, is output from the second MMI 112 through the second output port 112b.

In the optical switch 100 of one or more embodiments, the directional coupler 150 including the diode functioning as a heater is coupled and/or connected to at least one of the plurality of waveguides including the upper waveguide 131 and the lower waveguide 132 through which the first MMI 111 and the second MMI 112 are connected to each other. Thus, the directional coupler 150 may be directly heated using the diode. Thus, the phase of light may be modulated to direct an optical signal along an intended path by heating the directional coupler 150 to an intended temperature with significantly less power than heating by convection or conduction. In addition, a plurality of optical switches such as the optical switch 100 may be fabricated in a multi-stage structure to implement a light steering device capable of steering light.

In the example described above, the upper waveguide 131 includes the first waveguide portion 131a and the second waveguide portion 131b arranged apart from each other, and the directional coupler 150 forms an optical path between the first waveguide portion 131a and the second waveguide portion 131b. However, embodiments are not limited thereto. For example, the lower waveguide 132 may include waveguide portions arranged spaced apart from each other, and the directional coupler 150 may be provided in the lower waveguide 132. In addition, each of the upper waveguide 131 and the lower waveguide 132 may include waveguide portions arranged spaced apart from each other, and a directional coupler may be provided in each of the upper waveguide 131 and the lower waveguide 132.

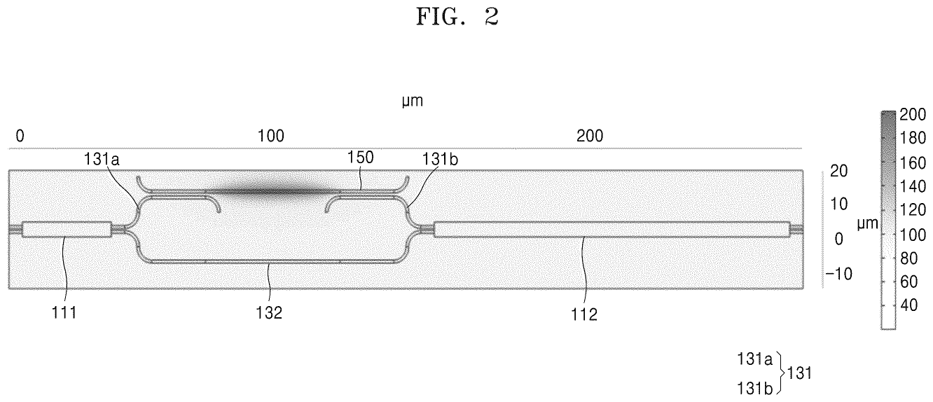

FIG. 2 is a simulation result illustrating an example of a temperature distribution of the optical switch 100 illustrated in FIG. 1.

FIG. 2 illustrates a result of a simulation in which a temperature distribution of the optical switch 100 according to one or more embodiments shown in FIG. 1 was calculated (obtained) when a power of 5 mW was applied to the diode (specifically, a p-i-n diode) provided in the directional coupler 150 of the optical switch 100. Referring to FIG. 2, the directional coupler 150 including the diode was measured to have a temperature of 177.12° C., and the lower waveguide 132 including no directional coupler was measured to have a temperature of approximately 21.631° C.

As described above, the power consumption of the optical switch 100 of one or more embodiments occurs mostly at the directional coupler 150 in which phase modulation takes place, thereby increasing thermal efficiency and ensuring chip stability. In addition, elements that need to be less affected by heat, such as the lower waveguide 132, are maintained at a temperature similar to room temperature, thereby reducing performance degradation of the optical switch 100.

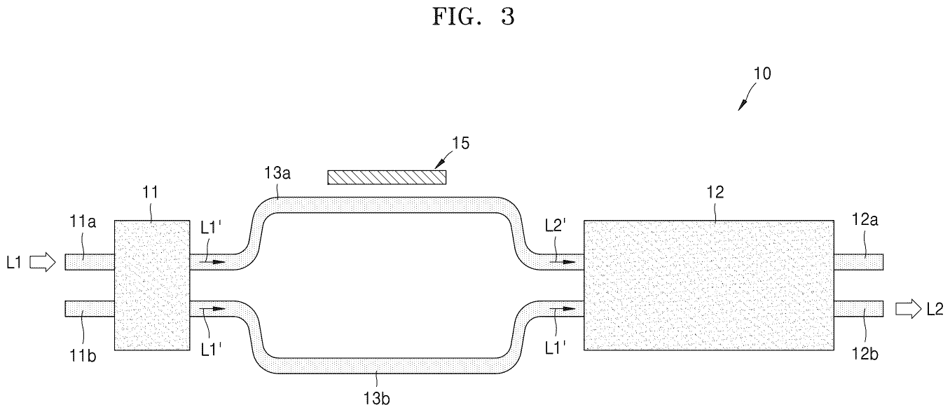

FIG. 3 illustrates an optical switch 10 according to a related embodiment. The optical switch 10 shown in FIG. 3 may be an MZI-type optical switch using an MMI. The following description focuses on differences from the embodiment described above.

Referring to FIG. 3, a first MMI 11 and a second MMI 12 are arranged spaced apart from each other on a substrate, and a plurality of waveguides including an upper waveguide 13a and a lower waveguide 13b connect the first MMI 11 and the second MMI 12 to each other. At least one of the first input port 11a and the second input port 11b through which a first beam L1 is input is connected to the first MMI 11, and a plurality of output ports including a first output port 12a and a second output port 12b through which a second beam L2 is output are connected to the second MMI 12.

The first MMI 11 and the second MMI 12 may be connected to each other by the plurality of waveguides including the upper and lower waveguides 13a and 13b. FIG. 2 illustrates an example in which two waveguides, that is, the upper waveguide 13a and the lower waveguide 13b, connect the first MMI 11 and the second MMI 12 to each other. The first beam L1 may be input into the first MMI 11 from the outside, for example, through the first input port 11a and may be divided into two sub-beams L1′ by the first MMI 11. The two sub-beams L1′ may be output through the upper waveguide 13a and the lower waveguide 13b, respectively.

A heater 15 may be provided adjacent to and around the upper waveguide 13a. Here, the heater 15 may heat the upper waveguide 13a to a predetermined temperature, and the phase of the sub-beam L1′ passing through the upper waveguide 13a may be modulated by the thermo-optic effect. The sub-beam L1′ output from the first MMI 11 and passing through the upper waveguide 13a is phase modulated by heating the upper waveguide 13a with the heater 15 and is converted into a modulated beam L2′.

The modulated beam L2′ of which phase is modulated in the upper waveguide 13a, and the sub-beam L1′ passing through the lower waveguide 13b are combined in the second MMI 12. In the second MMI 12, an output portion may be determined from the output port 12a and the second output port 12b based on a phase difference between the modulated beam L2′ and the sub-beam L1′. Then, a second beam L2 in which the modulated beam L2′ and the sub-beam L1′ are combined may be output through the determined output port.

In the optical switch 10 of a related embodiment, the heater 15 is provided around the upper waveguide 13a, and thus, heat transfers from the heater 15 to the upper waveguide 13a by conduction through a cladding layer or the like or by convection through air. As a result, thermal efficiency may be lower than when the upper waveguide 13a is directly heated.

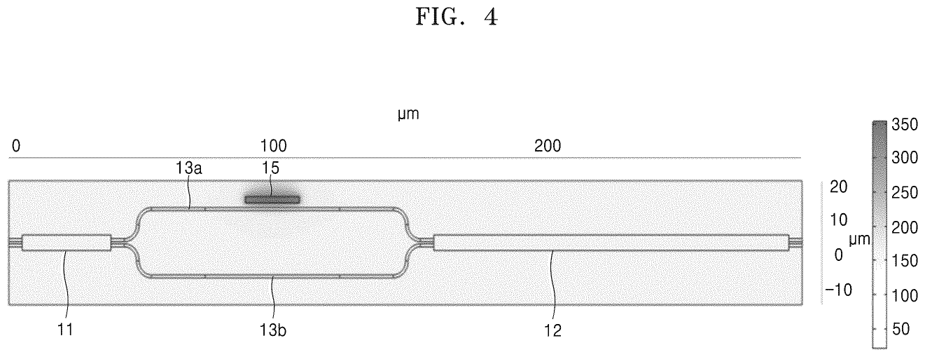

FIG. 4 is a simulation result illustrating an example of a temperature distribution of the optical switch 10 of the related illustrated in FIG. 3.

FIG. 4 illustrates a result of a simulation in which a temperature distribution of the optical switch 10 of the related embodiment shown in FIG. 3 was calculated (obtained) when a power of 5 mW was applied to the heater 15. Referring to FIG. 4, the upper waveguide 13a provided with the heater 15 was measured to have a temperature of 126.43° C., and the lower waveguide 13b provided with no heater was measured to have a temperature of 21.62° C.

When 5 mW was consumed, the upper waveguide 13a of the optical switch 10 of the related embodiment shown in FIG. 3 was measured to have a temperature of 126.43° C., but the directional coupler 150 of the optical switch 100 according to one or more embodiments shown in FIG. 1 was measured to have a temperature of 177.12° C. Therefore, when the same power is consumed, the optical switch 100 according to one or more embodiments shown in FIG. 1 may heat a target portion to a higher temperature and thus have higher thermal efficiency than the optical switch 10 of the related embodiment shown in FIG. 3.

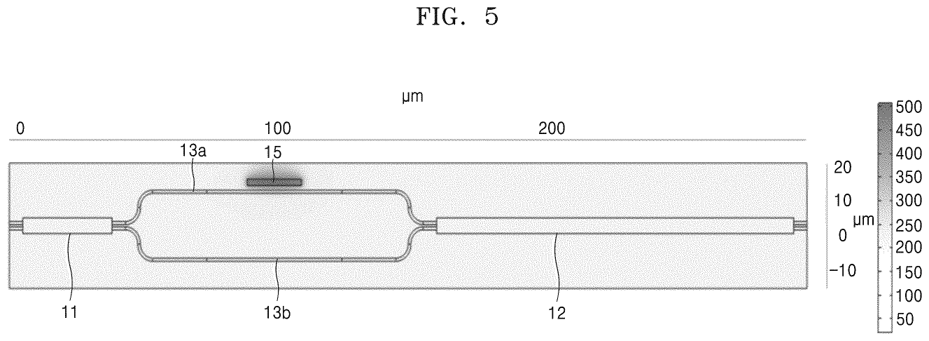

FIG. 5 is a simulation result illustrating another example of a temperature distribution of the optical switch 10 shown in FIG. 3.

FIG. 5 illustrates a result of a simulation in which a temperature distribution of the optical switch 10 of the related embodiment shown in FIG. 3 was calculated (obtained) when a power of 7.3 mW was applied to the heater 15. Referring to FIG. 5, the upper waveguide 13a provided with the heater 15 was measured to have a temperature of 177° C., and the lower waveguide 13b provided with no heater was measured to have a temperature of 22.366° C.

It may be understood that the optical switch 10 of the related embodiment shown in 3 requires about 1.5 times the power consumption of the optical switch 100 according to one or more embodiments shown in FIG. 1 to heat the upper waveguide 13a of the optical switch 10 to substantially the same temperature as the directional coupler 150 of the optical switch 100.

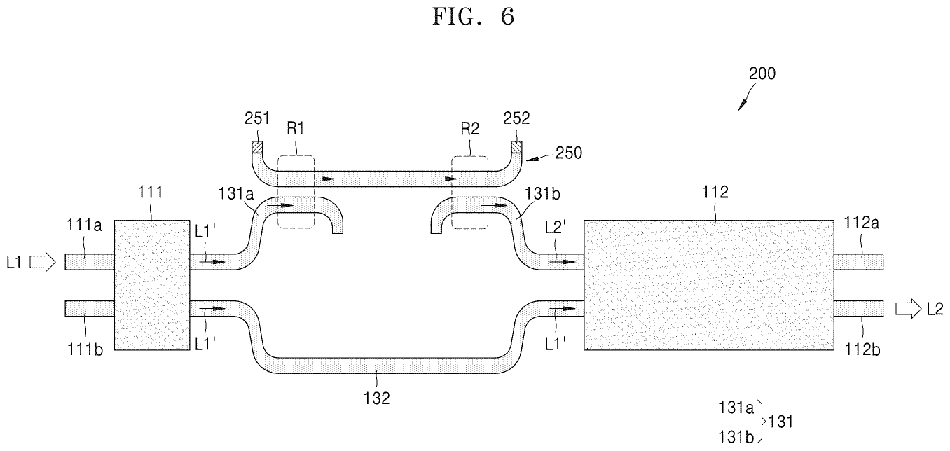

FIG. 6 schematically illustrates an optical switch 200 according to one or more other embodiments. The optical switch 200 shown in FIG. 6 may be an MZI-type optical switch using an MMI. The following description focuses on differences from the optical switch 100 according to one or more embodiments shown in FIG. 1.

Referring to FIG. 6, a first MMI 111 and a second MMI 112 are arranged spaced apart from each other on a substrate, and a plurality of waveguides including upper waveguide 131 and the lower waveguide 132 connect the first MMI 111 and the second MMI 112 to each other. At least one of first input port 111a and the second input port 111b through which a first beam L1 is input is connected to the first MMI 111, and a plurality of output ports through which a second beam L2 is output is connected to the second MMI 112.

The first MMI 111 and the second MMI 112 may be connected to each other by the plurality of waveguides including the upper waveguide 131 and the lower waveguide 132. Here, the plurality of waveguides including the upper waveguide 131 and the lower waveguide 132 may include, for example, a silicon-based material such as silicon, but are not limited thereto. FIG. 6 illustrates an example in which two waveguides, that is, the upper waveguide 131 and the lower waveguide 132, connect the first MMI 111 and the second MMI 112 to each other.

The first beam L1 may be input into the first MMI 111 from an outside of the optical switch, such as, for example, a light source or another MMI, for example, through the first input port 111a and may be divided into two sub-beams L1′ by the first MMI 111. Then, the two sub-beams L′ may be output through the upper waveguide 131 and the lower waveguide 132, respectively.

The upper waveguide 131 may include a first waveguide portion 131a and a second waveguide portion 131b that are spaced apart from each other. The upper waveguide 131 may be coupled and/or connected to a directional coupler 250. The directional coupler 250 may include, for example, a silicon-based material such as silicon, but is not limited thereto. The directional coupler 250 may form an optical path between the first waveguide portion 131a and the second waveguide portion 131b that are spaced apart from each other. To this end, a first coupling region R1 may be formed between the first waveguide portion 131a of the upper waveguide 131 and the directional coupler 250, and a second coupling region R2 may be formed between the second waveguide portion 131b of the upper waveguide 131 and the directional coupler 250.

The directional coupler 250 may include a diode to modulate, using the thermos-optic effect, the phase of the sub-beam L1′ passing through the directional coupler 250. A first doped region 251 and a second doped region 252 may be formed spaced apart from each other in the directional coupler 250. Here, the first doped region 251 and the second doped region 252 may be formed in the directional coupler 250 outside the first coupling region R1 and the second coupling region R2. For example, the first doped region 251 and the second doped region 252 may be formed at both ends of the directional coupler 250, respectively. When it is difficult to form the first doped region 251 and the second doped region 252 in a center portion of the directional coupler 250 due to process constraints, the first doped region 251 and the second doped region 252 may be formed at both ends of the directional coupler 250 as in the one or more embodiments. The diode may be configured as, for example, a p-i-n diode. However, embodiments are not limited thereto, and the diode may be configured as a p-i-p diode or an n-i-n diode.

The directional coupler 250 may be heated by applying current to the diode. Here, the directional coupler 250 may be heated to an intended temperature by adjusting the amount of current applied to the diode to modulate the phase of the sub-beam L1′ as intended.

The sub-beam L1′ output from the first MMI 111 and passing through the first waveguide portion 131a of the upper waveguide 131 is transferred to the directional coupler 250 through the first coupling region R1. The sub-beam L1′ passing through the directional coupler 250 is phase modulated by heating the directional coupler 250 with the diode and is thus converted into a modulated beam L2′. Then, the modulated beam L2′ is transferred to the second waveguide portion 131b of the upper waveguide 131 through the second coupling region R2.

The modulated beam L2′ passing through the second waveguide portion 131b of the upper waveguide 131, and the sub-beam L1′ passing through the lower waveguide 132 are combined in the second MMI 112. In the second MMI 112, an output port, for example, a first output port 112a or a second output port 112b, may be determined based on a phase difference between the modulated beam L2′ and the sub-beam L1′, and a second beam L2 in which the modulated beam L2′ and the sub-beam L1′ are combined may be output through the determined output port.

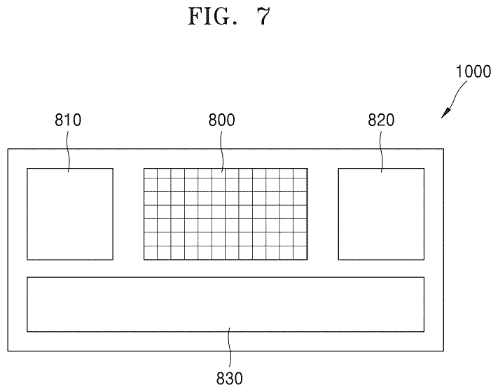

FIG. 7 illustrates a light steering system 1000 according to one or more embodiments FIG. 7 illustrates the light steering system 1000 to which the optical switches 100 and 200 of one or more embodiments described above are applied.

Referring to FIG. 7, the light steering system 1000 may include a light source 810 configured to emit light, a light steering device 800 configured to steer light emitted from the light source 810, a detector 820 configured to detect steered light, and a driving driver 830. For example, the light source 810 may be configured to emit frequency-modulated continuous wave (FMCW) light. The light source 810 may include, for example, a laser diode configured to emit a laser beam. However, embodiments are not limited thereto. The driving driver 830 may include a driving circuit configured to drive the light source 810, the light steering device 800, and the detector 820.

Light emitted from the light source 810 is incident on the light steering device 800. The light steering device 800 steers the incident light toward an intended position. To this end, the light steering device 800 may include a plurality of optical switches, and each of the plurality of optical switches may be any of the optical switches 100 and 200 of one or more embodiments described above.

When light steered by the light steering device 800 is projected onto an object and reflected from the object, the detector 820 may detect the light reflected from the object. For example, the light steering system 1000 may be applied to various fields, such as depth sensors, three-dimensional (3D) sensors, and light detection and ranging (LiDAR). While embodiments have been described, the embodiments are merely examples, and it will be understood by those of ordinary skill in the art that various modifications may be made in the embodiments.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. An optical switch comprising:
a first multimode interferometer;
a second multimode interferometer spaced apart from the first multimode interferometer;
a plurality of waveguides connecting the first multimode interferometer and the second multimode interferometer; and
a directional coupler connected to at least one waveguide of the plurality of waveguides, the directional coupler comprising a diode.

2. The optical switch of claim 1, wherein the at least one waveguide connected to the directional coupler comprises a first waveguide portion and a second waveguide portion spaced apart from the first waveguide portion, and
wherein the directional coupler is configured to provide an optical path between the first waveguide portion and the second waveguide portion.

3. The optical switch of claim 2, wherein the directional coupler and the first waveguide portion are arranged so that a first coupling region is formed between the directional coupler and the first waveguide portion, and the directional coupler and the second waveguide portion are arranged so that a second coupling region is formed between the directional coupler and the second waveguide portion.

4. The optical switch of claim 3, wherein the directional coupler is further configured to modulate, by heat generated from the diode, a phase of light passing through the directional coupler.

5. The optical switch of claim 4, wherein the directional coupler comprises a first doped region and a second doped region.

6. The optical switch of claim 5, wherein the first doped region and the second doped region are between the first coupling region and the second coupling region.

7. The optical switch of claim 5, wherein the first doped region and the second doped region are outside the first coupling region and the second coupling region.

8. The optical switch of claim 1, further comprising:
at least one input port connected to the first multimode interferometer; and
a plurality of output ports connected to the second multimode interferometer.

9. The optical switch of claim 1, wherein the plurality of waveguides comprise a silicon-based material.

10. The optical switch of claim 1, wherein the directional coupler comprises a silicon-based material.

11. A light steering system comprising:
a light source;
a light steering device comprising a plurality of optical switches configured to steer light incident from the light source; and
a detector configured to detect the steered light,
wherein each of the plurality of optical switches comprises:
a first multimode interferometer;
a second multimode interferometer spaced apart from the first multimode interferometer;
a plurality of waveguides connecting the first multimode interferometer and the second multimode interferometer; and
a directional coupler connected to at least one waveguide of the plurality of waveguides, the directional coupler comprising a diode.

12. The light steering system of claim 11, wherein the light source is configured to emit frequency modulated continuous wave (FMCW) light.

13. The light steering system of claim 11, wherein the at least one waveguide connected to the directional coupler comprises a first waveguide portion and a second waveguide portion spaced apart from the first waveguide portion, and
wherein the directional coupler is configured to provide an optical path between the first waveguide portion and the second waveguide portion.

14. The light steering system of claim 13, wherein the directional coupler and the first waveguide portion are arranged so that a first coupling region is formed between the directional coupler and the first waveguide portion, and the directional coupler and the second waveguide portion are arranged so that a second coupling region is formed between the directional coupler and the second waveguide portion.

15. The light steering system of claim 14, wherein the directional coupler comprises a first doped region and a second doped region.

16. The light steering system of claim 15, wherein the first doped region and the second doped region are between the first coupling region and the second coupling region.

17. The light steering system of claim 15, wherein the first doped region and the second doped region are outside the first coupling region and the second coupling region.

18. The light steering system of claim 15, further comprising:
at least one input port connected to the first multimode interferometer; and
a plurality of output ports connected to the second multimode interferometer.

19. The light steering system of claim 15, wherein the plurality of waveguides comprise a silicon-based material.

20. The light steering system of claim 15, wherein the directional coupler comprises a silicon-based material.
